(19) United States
(12) Patent Application Publication
(10) Pub. No.: US 2026/0099866 A1
(43) Pub. Date: Apr. 9, 2026

(54) System and Method for Creating and Delivering Digital Media Assets

(71) Applicant: Adhawk AI, Inc., Pittsburgh, PA (US)

(72) Inventors: Amber Raschel Aurora Brown, Pittsburgh, PA (US); Paul Beardsley, Zürich (CH); Joseph William Marks, Boston, MA (US); Ronald N. Perry, Cambridge, MA (US); Carter Bart Sullivan, Benicia, CA (US)

(21) Appl. No.: 19/305,672

(22) Filed: Aug. 20, 2025

Related U.S. Application Data
(60) Provisional application No. 63/703,873, filed on Oct. 4, 2024.
(60) Provisional application No. 63/710,326, filed on Oct. 22, 2024.
(60) Provisional application No. 63/715,465, filed on Nov. 1, 2024.
(60) Provisional application No. 63/717,109, filed on Nov. 6, 2024.
(60) Provisional application No. 63/719,427, filed on Nov. 12, 2024.

(51) Int. Cl. G06Q 30/0241; G06Q 30/0251; G06Q 30/0273

(52) U.S. Cl. CPC G06Q 30/0277; G06Q 30/0251; G06Q 30/0275; G06Q 30/0276

(57) ABSTRACT

A system and method for context-driven digital media assets generation and bidding in programmatic advertising environments is disclosed. In one configuration, during an advertising auction, the system obtains contextual information from one or more sources associated with a digital media environment (e.g., a website). The contextual data includes, at least in part, information characterizing user interactions with the environment. Utilizing this data, the system dynamically generates one or more digital media objects (e.g., images) whose content is contextually related to the digital media environment and user activity. These media objects are used to generate advertisements that may be submitted with a bid, generated upon winning the auction, or partially constructed prior to the bid and completed after the bid is won.

### CROSS-REFERENCES TO PRIORITY AND RELATED APPLICATIONS

This application is a non-provisional of, and claims the benefit of and priority from:
1) U.S. Provisional Patent Application No. 63/703,873 , filed Oct. 4, 2024, entitled “System for Creating and Delivering Real-Time, Context-Aware Advertisements Using Generative AI”;
2) U.S. Provisional Patent Application No. 63/710,326 , filed Oct. 22, 2024, entitled “Multistage System for Creating and Delivering Real-Time, Context-Aware Advertisements Using Generative AI”;
3) U.S. Provisional Patent Application No. 63/715,465 , filed Nov. 1, 2024, entitled “Multistage System for Specifying, Generating, and Delivering Real-Time Advertisements Using Generative AI”;
4) U.S. Provisional Patent Application No. 63/717,109 , filed Nov. 6, 2024, entitled “Method and System for Rendering Fonts in Generative AI Systems”; and
5) U.S. Provisional Patent Application No. 63/719,427 , filed Nov. 12, 2024, entitled “Autonomous Content Filtering System and Method for AI-Generated Advertisements.”

The entire disclosures of applications/patents recited above are hereby incorporated by reference, as if set forth in full in this document, for all purposes.

### FIELD

The present disclosure generally relates to customized digital media generation and delivery, and in particular to directed media for a consumer during a course of an online electronic transaction.

### BACKGROUND

Advertising is a form of media used to draw attention to a product or service, with the goal of presenting its utility, advantages, and qualities in ways that resonate with consumers. The practice dates back to ancient civilizations. For example, the Egyptians used papyrus to display sales messages and posters, and both commercial and political messages have been discovered in the ruins of Pompeii. Modern advertising began to take shape with the advent of newspapers and magazines in the 16th and 17th centuries, then accelerated dramatically following the Industrial Revolution, which expanded both the supply of manufactured goods and the size of consumer markets. In the 20th century, the emergence of new distribution technologies, such as direct mail, radio, television, the internet, and mobile devices, transformed advertising into a dynamic, multi-channel enterprise. Today, advertising surrounds consumers across nearly all media environments, with individuals estimated to encounter hundreds of ads each day.

Digital advertisements are a form of digital media which typically includes a collection of digital media assets, including ad copy (persuasive written content), visual collateral (such as logos, product or packaging imagery, and other design elements), audio, video, and augmented reality components. Online advertising, also referred to as internet, digital, or web advertising, involves the presentation of these digital media assets via web pages, mobile apps, connected televisions, and other digital platforms.

As digital advertising has evolved into a core form of digital media, it has adopted increasingly sophisticated strategies for content creation and delivery. A key innovation in modern digital advertising has been the ability to deliver media assets selectively targeted toward specific users based on their attributes or behaviors. Targeting may focus on demographic data (such as age, location, education, or income), psychographic traits (such as interests, values, or lifestyle), or behavioral signals (such as browsing history or purchasing activity). Placement targeting, for example, involves choosing specific websites or applications where ads will appear, such as placing hotel ads on airline booking platforms. Device targeting delivers digital ads based on the type of device in use, and geographic targeting restricts delivery to a specified location, such as within a 20-mile radius of a business.

Keyword targeting is another widely used approach, triggering ads based on user-entered search terms or contextual keywords on the page. It can also be combined with placement targeting. For instance, placing an airline ad on a travel blog that contains destination-related terms.

Additional targeting strategies leverage cookies, small data packets stored in a user's browser, to track visits, preferences, and online behavior. Cookies support both demographic and behavioral targeting, such as showing luxury car ads to high-income users or gardening tools to users who recently searched for lawn care.

Retargeting is a common behavioral strategy where users who previously visited a site but did not convert (e.g., did not make a purchase) are shown follow-up ads on other sites. For example, a consumer who visited a hotel booking site but did not complete a reservation might later see ads for the same hotel elsewhere online.

Although targeting strategies have improved marketers' ability to reach relevant audiences, they still rely on static, pre-authored digital media creatives linked to generalized audience traits. These conventional approaches lack the flexibility to dynamically respond to the nuanced, real-time contexts in which consumers engage with digital media.

Therefore, in today's media landscape, defined by personalization, contextual relevance, and rapid user interaction, there is a growing need for improved systems that can automatically scale the creation and delivery of digital media content to align with the dynamic range of user contexts and presentation environments, and distribute them efficiently across a variety of digital platforms.

### SUMMARY

To meet joint challenges of a very large number of potential consumer contexts, and the responsiveness required to bid and serve digital media, such as an advertisement, in the programmatic ecosystem, an implementation sources context from the auction and enlists computer systems, such as GenAI, to combine that information with advertiser goals to immediately generate and place an appropriate contextually relevant advertisement in a media insertion point, such as an ad slot. This is different from authoring or pre-generating advertisements ahead of time for later placement in that, in this method, at least a portion of the advertisement does not exist until the programmatic auction is initiated and systems described herein, such as GenAI, are engaged to generate the advertisement. Moreover, because the advertisement is generated dynamically using context data received at or near the time the media slot becomes available, subsequent to the initiation of a programmatic action, the resulting advertisement is contextually aligned with the media environment into which it is placed. This alignment ensures that the advertisement satisfies a threshold level of contextual relevance relative to the attributes of the target media environment at the time of insertion.

In one implementation, during an advertising auction, for instance, in a programmatic ad buying ecosystem, context information is obtained by a system from at least one source associated with the auction such as a digital media environment (e.g., website). The context data, at least in part, includes information that characterizes user interaction with the digital media environment. During the auction, the system utilizes at least some of the contextual information in the creation of one or more media objects, such as an image. Here, since the context data used to help create the one or more media objects relates, at least in part, to information characterizing the user interaction with the digital media environment, the context of the one or more media objects also relates at least partially to the digital media object. A bid is transmitted to partake in the auction. In response to a bid acceptance, the system generates an advertisement using one or more of the media objects to send with the bid. In response to winning the bid, the system generates an advertisement using one or more of the media objects for presentation to the user.

In another configuration, a computer-implemented method is described for generating an advertising object to be inserted into an advertising slot made available via a programmatic ad-buying platform. The method includes determining a context data object, where the context data object includes at least some context of the user session presentation and/or context of the advertising slot. The method further includes determining that an advertising auction has opened that entails bidding for placement of an advertising object in an advertising slot. After the advertising auction has opened one or more creative media objects are generated based, at least in part, on the context data object. The one or more creative media objects are combined to form one or more advertisement objects usable for placement in the ad slot. A bid is used to place a bid for the advertisement into the advertising auction. If the bid wins the advertising auction, then providing the advertisement for insertion in the advertising slot.

In one configuration, a computer implemented-method is described for delivering contextually relevant advertising during a private placement, preferred deal, or programmatic guaranteed deal. The method includes obtaining context data that characterizes an active user session within a digital media environment. In a first operation, the context data is used to dynamically generate one or more creative media objects, which are assembled into an advertisement object tailored to the session context. In a second operation, the advertisement is prepared and transmitted for presentation to the user, enabling real-time, personalized ad delivery based on session-specific attributes.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various implementations of the disclosure and illustrated in the accompanying drawings.

### BRIEF DESCRIPTION OF THE DRAWINGS

Various implementations in accordance with the present disclosure will be described with reference to the drawings, in which:

FIG. 1 illustrates a data-flow diagram for programmatic advertising.

FIG. 2 illustrates a data-flow diagram for programmatic advertising employing artificial intelligence (AI) authored digital media assets.

FIG. 3 illustrates a method for generating ad-copy digital media assets with AI.

FIG. 4 illustrates a method for generating visual-collateral digital media assets with AI.

FIG. 5 illustrates a method for generating digital media assets and the resulting digital media assets for a vehicle ad.

FIG. 6 illustrates a digital media asset presented on a display as an ad for a vehicle.

FIG. 7 illustrates a method for creating digital media assets and an example resulting digital media assets for a luggage ad presented on a webpage directed to women.

FIG. 8 illustrates a digital media asset rendered as an ad for luggage directed to women presented on a webpage.

FIG. 9 illustrates a digital media asset rendered as an ad for luggage directed to men presented on a webpage.

FIG. 10 illustrates a method for generating digital media assets and the resulting digital media asset for a blender ad.

FIG. 11 illustrates the digital media asset for a blender being presented in a mobile shopping application.

FIG. 12 illustrates the resulting digital media assets for a cereal product ad.

FIG. 13 illustrates the digital media asset for a cereal product being presented in an Augmented Reality (AR) application.

FIG. 14 illustrates the resulting digital media assets for an ad for a magazine.

FIG. 15 illustrates the digital media asset for a magazine product being presented as an advertisement on a woman's tennis website.

FIG. 16 illustrates an example computer system memory structure as might be used in performing methods described herein, according to one or more example of principles described herein.

FIG. 17 is a block diagram illustrating an example computer system upon which the systems illustrated in FIGS. 1, 2, etc., and FIG. 16, may be implemented, according to one or more example of principles described herein.

In the figures, elements having similar designations might or might not have the same or similar functions.

### DETAILED DESCRIPTION

In the following description, specific details are set forth describing some examples consistent with the present disclosure to provide a thorough understanding of the teachings herein. It will be apparent, however, to one skilled in the art that some examples may be practiced without some or all of these specific details. Well-known features may be omitted or simplified in order not to obscure the examples being described. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

Disclosed implementations relate to systems and methods for generating and delivering media content responsive to real-time placement opportunities within digital environments. In one implementation, a computing system detects the availability of a media slot, such as an ad slot, in-stream content break, or dynamic insertion point, and obtains context data characterizing the media slot, media environment, and/or the associated user session. Based on this context data, the system generates one or more creative media components (e.g., images, text, audio, or video) and assembles them into a complete media object suitable for placement within the media environment. If the media slot is governed by a selection process (e.g., auction, ranking, or scheduling), the assembled object, or representation thereof, may be submitted for consideration.

Upon selection, the system transmits the media object for rendering in the slot. Because media generation occurs after the slot becomes available and is informed by its contextual attributes and the contextual attributes of the media environment, the delivered content is inherently contextually aligned with the media environment, enhancing relevance and performance across use cases including advertising, editorial content, promotions, and informational messaging.

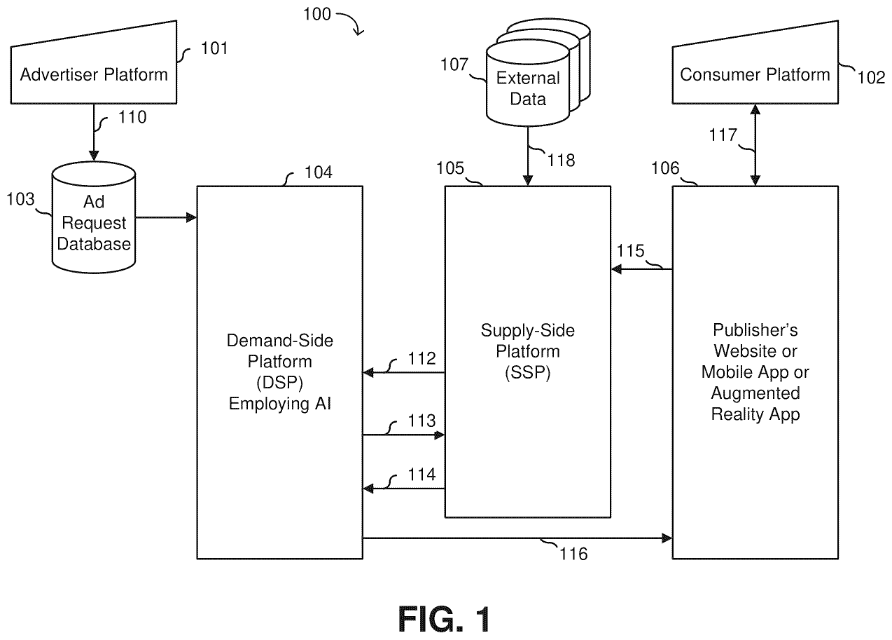

In one configuration, FIG. 1 illustrates a system 100 for programmatic delivery of digital media such as images, videos, advertisements, etc. In one configuration, in response to system 100 receiving a media request for a digital media asset, such as an advertisement, from platform 101 (e.g., an advertiser's platform), system 100 receives and passes digital media assets 110 for the ad and accompanying metadata to an ad-request database 103. To effectuate timely delivery of a media asset, the advertisement requests and associated digital media assets are typically stored in the ad-request database 103 in advance of any media request by the advertiser.

A user (e.g., consumer), using a consumer platform 102, requests data via a connection 117 from a publisher's platform 106, which might be a website, a mobile app, or a video-streaming service running on a second computer, etc. Publisher's platform 106 sends data via a connection 115 regarding the consumer and consumer's interaction data via connection 117 to a supply-side platform (SSP) 105, which may be a software agent running on a computer. This information may be used for ad targeting, as described herein. The information conveyed in data delivered via connection 115 can include data such as the URL of the website, the consumer's IP address or geographic location, information about the consumer's computing device, demographic and behavioral data about the consumer that can be gleaned from the interaction data via connection 117, including cookie data retrieved during the interaction, etc.

Supply-side platform (SSP) 105 may negotiate with a demand-side platform (DSP) 104, typically operating on another computer, to find an advertisement that can be served to the consumer who is interacting with publisher's platform 106.

In one configuration, SSP 105 combines data delivered via connection 115 sent from publisher's platform 106 with data 118 from external databases 107. For example, one of these external databases 107 might contain geographic locations corresponding to IP addresses. As a second example, one of these external databases 107 might contain context data, such as census data, local temperature, etc.

Upon SSP 105 sending context data via a connection 112 to DSP 104, DSP 104 compares this context data received via connection 112 about the consumer and its interaction against ad requests stored previously by the advertiser in ad-request database 103. Depending on how well an ad request matches the targeting information delivered via connection 115 and on other factors such as pricing, metadata stored with the ad request in ad-request database 103, etc., DSP 104 will present a bid via a connection 113 to SSP 105 for the right to present the ad to the consumer via connection 117 with publisher's platform 106. SSP 105 then evaluates the bid. If the bid is acceptable, SSP 105 sends an acknowledgement via a connection 114 to DSP 104 that its bid has been successful, and provides information needed via connection 114 for DSP 104 to serve ad content via a connection 116 to publisher's platform 106, which ad content is then presented via the ongoing consumer's interaction via connection 117. Payment is typically transacted from the advertiser to the publisher via DSP 104 and SSP 105 intermediaries.

In one example of programmatic ad buying, as illustrated in FIG. 1, an advertiser purchases space on a publisher's platform to present an advertisement to a specific target consumer via an automated negotiation between software agents, one agent representing the advertiser and another agent representing the publisher. The automated negotiation often uses an auction mechanism whereby the publisher's software agent will sell advertising space on the publisher's online platform to the advertiser's agent that makes the highest bid. The auction can be one or more of a first-price auction, a second-price auction, a Vickery auction, a private marketplace auction, a hybrid first-and second-price option, a Dutch auction, a dynamic floor price mechanism, a cryptographic verification auction, a sequential auction, a sequential auction with a learning algorithm, a token-based auction, private placement, procurement deal, a blockchain auction, etc.

To enable targeted advertising, the publisher's software agent might provide context data or data that can be linked to context data about the target consumer's traits. The advertiser's agent might take the context data into account when deciding how much to bid to present an advertisement to that consumer. The publisher's software agent awards the advertising space to the advertiser's agent with, for example, the highest bid. The advertiser's agent then serves the advertisement to the consumer via the publisher's platform. The actions taken by the advertiser's and publisher's agents typically occur under auction window timing constraints, e.g., two hundred milliseconds.

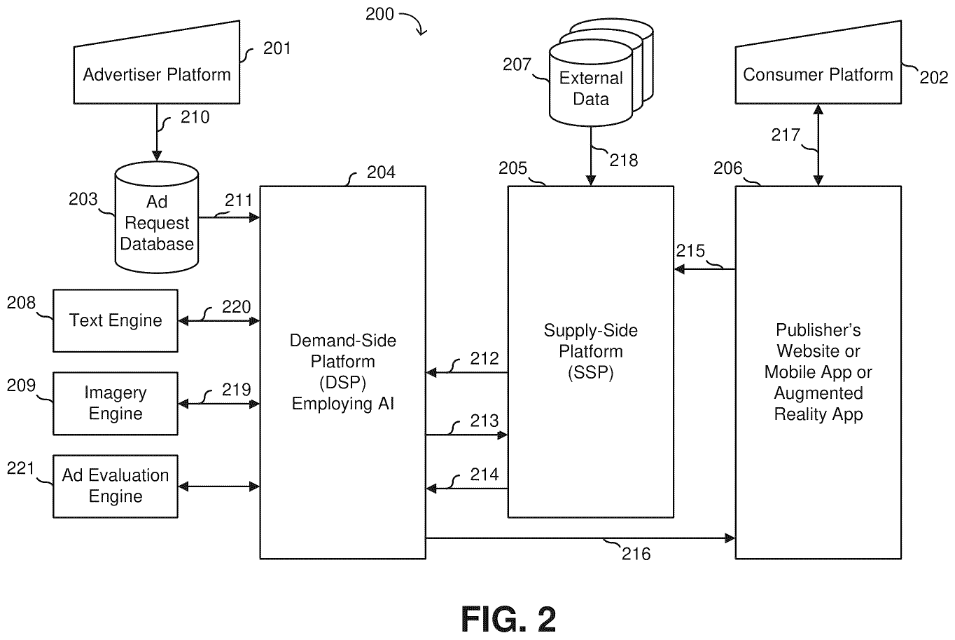

FIG. 2 illustrates a data-flow diagram of a system 200 for providing digital media assets, created in real time, or near real time, and customized to a consumer's context data associated with the media environment such as a context of a virtual world and/or the physical world. The disclosure herein thus extends programmatic advertising to be a form of programmatic marketing, which can involve understanding user needs based on their context in the physical and virtual worlds and developing advertising strategies to meet them.

In one implementation, system 200 employs computers, GPUS, Generative AI (GenAI) tools, LLMs., and the like, to achieve on-the-fly, real-time, or near real-time, context-aware presentation of customized advertisements within a programmatic ad-buying system. Similarly numbered elements in FIG. 2 might use elements described in FIG. 1, but that need not be the case. Referring to FIG. 1 and FIG. 2, in lieu of an advertiser providing a preauthored advertisement as illustrated in FIG. 1 from platform 101, the advertiser instead might provide a description of the product the advertiser, user, etc., wishes to promote and provide a description data object to the advertiser platform.

This description might be written by the advertiser, or might be copied from an existing source, like a web page devoted to the product. The description data object might be augmented with other data, including marketing guidelines for the product's brand, marketing goals, customer information, campaign information, market-research data about the product, a list of competing products, and a list of complementary products that might be used alongside the target product. The description and data describing the product and marketing goals might be in the form of text, charts, graphs, images, audio, video, and/or form responses such as drop-down menus, etc. The description plus additional data might be combined with metadata concerning ad targeting and/or pricing to make a complete ad request, and ad request data delivered by a platform 201 via a connection 210 to be stored by an ad-request database 203.

In one implementation, prior to communicating a bid via a connection 213 to an SSP 205, a DSP 204 might employ a GenAI engine to author the digital media assets for a customized ad promoting the advertiser's product.

If the bid is acceptable, SSP 205 sends an acknowledgement via a connection 214 to DSP 204 that its bid has been successful, and provides information needed via connection 214 for DSP 204 to serve ad content via a connection 216 to publisher's platform 206, which ad content is then presented via the ongoing consumer's interaction via connection 217. DSP 204 can then combine ad-request data from ad-request database 203 received via a connection 211 with the same context data via a connection 212 that is being provided by SSP 205 for targeting purposes, and can feed at least some of context data as one or more prompts to text engine 208 that is configured to generate an ad-copy media asset for the AI-authored ad, and feeds at least some of the context data via a connection as one or more prompts to an imagery engine 209 configured to generate a visual-collateral media asset for the AI-authored ad. Text engine 208 used to generate the ad-copy media asset may be a process designed to generate text via instructions such as a Large Language Model (LLM), and imagery engine 209 may be a model, such as a GenAI, stable-diffusion model, and/or the like, capable of generating a visual-collateral media asset.

The visual-collateral media assets may be static images, video, or combinations thereof. The GenAI process configured to generate textual media assets via text engine 208 and the GenAI process configured to generate visual media assets via imagery engine 209 may contain large numbers of representations of successful advertising principles and ad exemplars. In addition, the GenAI processes may include other data that assist in creation of appropriate real-time digital media assets such as representations of knowledge about the world, products, brands, typical brand contexts, consumption behaviors, demographic and psychographic trends and tendencies, geography, lifestyle, human culture, and behaviors, etc.

Context data sources may be very diverse. For some programmatic ad placements, data may be sparse. For instance, the user might have cookies blocked and privacy settings increased in a web browser and only the information about the URL being viewed might be available. For other programmatic ad placements, a rich history of the user's demographics, behavior and current activity might be available. In these and other situations, GenAI processes may be used to combine the available data from the context with the advertiser goal into creative data objects determining the subject matter of the imagery, the appropriate tagline and other elements forming an ad.

Context data may include, but is not limited to, URLs and domain structure; webpage text: HTML body content, headlines, metadata; keywords; HTML meta tags, IAB and other category codes with a standardized classification of content, tags and taxonomies, visual content, alt tags, image recognition, video content, transcript, frame image analysis, scene or face recognition, speech recognition and keywords, emotional tone, speaker identity, app metadata, app content data, user-based context, cookies, local storage/session storage, device identifiers, (IDFA, GAID, MAC address), geolocation, IP, browser fingerprinting, biometric data, sensor data from device, accelerometer, gyroscope, light sensors, OS and device characteristics, behavioral and historical data, search queries, clickstream data, ad interaction history, purchase and conversion history, login status, time of day, date, day of week, recency/frequency metrics, CRM and DMP integrations, unified ID, social media history, first-party databases such as CRM and purchase data, site behavior; third-party data providers providing demographics, interest and affinities, purchase intent signals, household purchase, behavior and ownership data, Customer Data Platforms, Data Clean Rooms; contextual environment and signals, location data, GPS, IP, Beacon/Wi-Fi, weather, current events, news events, language and local settings, compliance and consent signals, consent strings, privacy signals from browsers, privacy signals from apps, social media post text and captions, hashtags and mentions, likes, shares, comments, view through rates, creator metadata, follower count, topic category, verified status, social graph, network of social connections, influencer interaction paths, social content type, interaction timing, video metadata, video and image brand logos, video and image product placement, scene classification, channel data, creator category, channel subscriber count, viewer behavior, playlist inclusion, content recommendation context, skip behavior, hover behavior, connected TV program-level metadata, show title, genre, episode, AR metadata and content context, VR metadata and content context, smart TV model and OS, AR model and OS, VR model and OS, podcast metadata, host-read vs dynamically inserted content, listener behavior, listening context, background play status, connected devices, subscription tier, playlist inclusion, and/or cross-platform ID graphs, etc.

More information may be acquired and utilized for the purpose of ad generation. Publisher's platform 206 may, subject to granular user consent defined by an IAB-compliant Transparency & Consent Framework (e.g., TCF v2.2) string, transmit optional context extensions via connection 212 and connection 215 such as local weather, temperature, geo-location information, physiological signals from a paired wearable, etc. Biometric or psychographic fields—examples include heart rate, blood glucose, or credit score SHA-256 digests—may be hashed on-device by DSP 204 only as k-anonymized buckets, thus meeting CCPA and GDPR “data-minimization” requirements while still enabling creative personalization.

A third alteration to the programmatic ad-buying methodology in FIG. 2 also impacts DSP 204. Ads generated by text engine 208 and imagery 209 may then be sent to an automated ad-evaluation engine 221 to determine whether an ad is acceptable according to one or more criteria, some of which are described herein, which is communicated back to DSP 204. The acceptable ad may then be served via connection 216 to publisher's platform 206 for presentation to consumer platform 202 via the consumer's interaction through connection 217 with publisher's platform 206.

In another implementation, media asset generation using text engine 208 and imagery engine 209 and ad-evaluation engine 221 is done prior to DSP 204 providing a bid via connection 213 to SSP 205, so that the DSP 204 can determine an appropriate acceptance criteria, such as price, for the bid.

In one implementation, ad-evaluation engine 221 is used to determine the best ad, or an ad that meets one or more quality thresholds. In one implementation ad-evaluation engine 221 considers the readability of the ad copy generated by text engine 208 using scoring algorithms such as the Flesch-Kincaid readability score or similar scoring algorithm. Ad-evaluation engine 221 might also consider rhetorical devices such as alliteration, consonance, and assonance in advertising copy which can enhance memorability, persuasion, and consumer engagement, offering early insight into the psychological impact of phonetic repetition in marketing communications. Ad-evaluation engine 221 might also consider the Language Model Score (LMS), which uses a semantic embedding to estimate the probability of each term in the ad-copy text given the surrounding terms. If the semantic embedding is based on examples of high-quality marketing text, then the LMS will give some measure of how good the ad-copy text is in terms of its marketing utility.

In one implementation, ad-evaluation engine 221 may be configured to follow a multi-stage scoring pipeline to assess the quality of a generated advertisement: Step 1—Readability: The advertising copy is evaluated using the Flesch-Kincaid Grade Level (denoted G). A readability score R is computed, for example, as: R=max(0, 100-6·G). This penalizes overly complex language by reducing the score proportionally to reading grade level. Step 2—Language Model Quality (LMS): The headline and body text are embedded using a dimensional Sentence-Transformer model (e.g., 768-dimensional Sentence-Transformer model). A language quality score S is calculated as the mean of log-probabilities, reflecting fluency and coherence as assessed by the model. Step 3—Visual Aesthetics: A classifier such as the ResNet-50 classifier, fine-tuned on the Aesthetic-HQ dataset, evaluates any accompanying imagery or layout. The output is a visual score V in some defined range such as the range [0, 100]. Step 4—Composite Scoring: The final quality score Q is a weighted combination of the three individual scores: Q=0.35·R+0.40·S+0.25·V. Ad creatives that fall within a threshold (e.g., with Q≥75) are passed forward for bidding. Ads that fall below this threshold trigger a feedback signal, prompting the generation module to increase factual specificity in the next beam-search iteration.

To measure the relevancy of the ad to the user's context, ad-evaluation engine 221 might also compare the generated ad-copy text against the prompt given to text engine 208, assigning a contextual relevancy value to the ad and using it to rank more highly ads that refer to terms in the prompt. Lower rank ads, such as those that do not meet sufficient contextual relevancy and/or sufficient ad quality may result in bid withdrawal or not submitting them for placement. ad-evaluation engine 221 also assesses the quality of the visual collateral generated by imagery engine 209. Criteria for the visual imagery might include a measurement of the quality of the typography in the image, if any. Visual collateral might also be rated based on its originality or on other aesthetic criteria. In one implementation, ad-evaluation engine 221 might communicate information about ad quality to text engine 208 and imagery engine 209 in an iterative adjustment loop to improve the quality of the final ad served by DSP 204 to publisher's platform 206.

In another implementation, the generation of the creative media objects forming the advertisement using text engine 208 and imagery engine 209 may occur at least in part after the bid has been accepted. Placeholder media objects may be used to reserve the advertising slot, providing details of the advertisement sufficient to represent the advertisement to a third party for bid acceptance.

An alternative that uses traditional GPUs is to deploy language and image generation models that provide the performance required for real-time on-the-fly advertisement creation. In this implementation, the system leverages generative AI architectures tuned for inference efficiency on conventional GPU hardware. These advanced models from leading technology companies incorporate architectural improvements and optimization techniques that enable rapid simultaneous generation of both advertising copy and visual content within millisecond timeframes. The system employs these highly efficient generative models to produce contextually relevant textual advertisements and corresponding visual imagery, ensuring cohesive brand messaging where visual elements are semantically aligned with the generated text while maintaining the real-time performance characteristics necessary for dynamic advertising applications.

In one configuration, at least a portion or the entirety of DSP 204 may be executed by one or more computing systems configured for high-performance inference tasks. Such systems may include, for example, GPU-accelerated inference clusters comprising one or more graphics processing units (GPUs) (e.g., NVIDIA L40S, A100, H100, AMD Instinct MI300, etc.), tensor processing units (TPUs), application-specific integrated circuits (ASICs), field-programmable gate arrays (FPGAs), or other specialized accelerators. In certain configurations, the computing system may be interconnected using high-throughput communication interfaces (e.g., NVLink™, PCIe Gen5, InfiniBand, or Ethernet fabrics) and may be front-ended by a high-speed memory cache (e.g., Redis™, Memcached, or custom in-memory caching systems). For efficiency, static prompt tokens may be pre-computed and stored in the cache, such that only dynamic user-context tokens need to be appended at inference or serve time.

In an implementation, to satisfy real-time or near real-time on-the-fly performance requirements, a lightweight or distilled language model may be employed. For example, a language model comprising approximately three billion parameters may be quantized to low-bit precision (e.g., 4-bit weights) and executed using optimized inference software (e.g., TensorRT™, ONNX Runtime, or other inference frameworks). Such a configuration may achieve average generation latencies suitable for real-time applications (e.g., generating approximately 40 tokens in under 30 milliseconds).

The language model may be used in conjunction with an image generation model configured to produce accompanying visual media assets. For instance, an efficient image synthesis model (e.g., a variant of Stable Diffusion, diffusion-lite models, or compact U-Net architectures) may be configured to generate static images (e.g., 512×512 pixels) using low-precision compute (e.g., INT8 or FP8 quantization) and optimized kernels, achieving render times on the order of 40-50 milliseconds.

The remaining time budget within a real-time media auction cycle (e.g., 200 milliseconds) may accommodate other latencies such as network round-trip time (e.g., approximately 60 milliseconds at the 95th percentile) and auxiliary processing overhead such as media assembly, prompt completion, or formatting (e.g., 20 milliseconds). This illustrative implementation demonstrates that real-time generative media pipelines may be deployed using commercially available hardware and standard inference frameworks.

In another configuration, to meet the performance demands of real-time or near-real-time operation, the system employs inference hardware and software configurations designed to generate multi-modal content with sub-second latency. The inference engines may be deployed on hardware platforms optimized for low-latency and high-throughput workloads.

For example, such platforms may include tensor streaming processors or similar streaming architectures capable of deterministic inference with minimal response time variability. Alternatively, the system may utilize massively parallel processing architectures such as wafer-scale compute engines or other parallelized processing arrays optimized for transformer-based model execution.

These advanced hardware solutions—whether based on custom silicon, general-purpose graphical processing units (GPUs), field-programmable gate arrays (FPGAs), or application-specific integrated circuits (ASICs)—enable the inference pipeline to maintain consistent millisecond-range performance across a wide range of content-generation scenarios. This ensures that context-aware advertisements or other dynamically generated media assets can be delivered within the strict time constraints typical of programmatic advertising environments or other latency-sensitive deployment contexts.

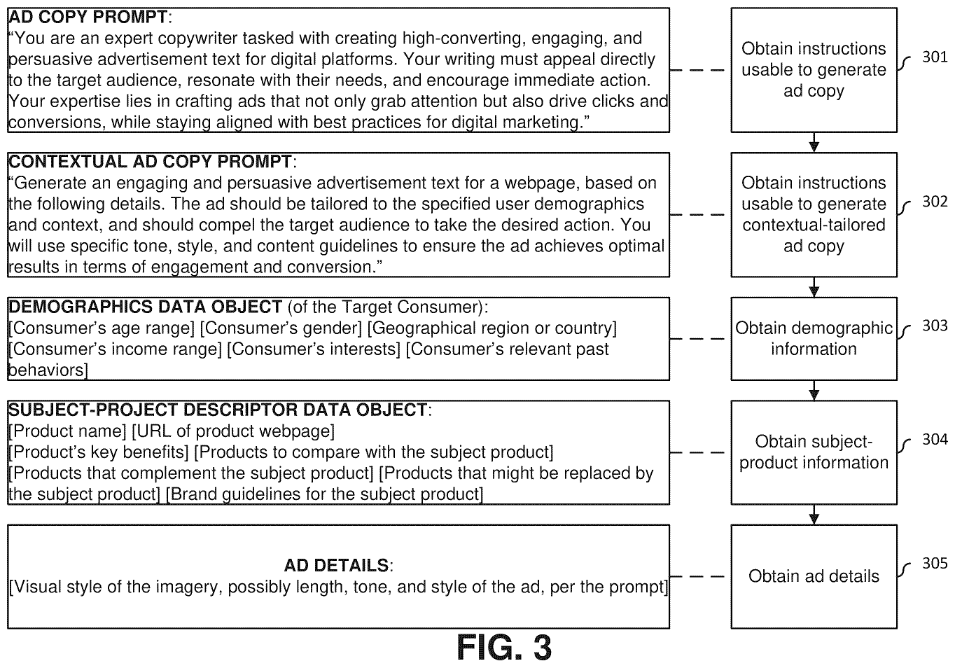

In one implementation, a prompt fed via connection to DSP 204 for generating ad-copy media assets follows a template such as the template shown in FIG. 3. At 301, a set of computer-executable instructions, such as one or more prompts, may be provided to a media generation process (e.g., text engine 208), the instructions being configured to initiate the generation of one or more textual media assets according to general content creation criteria. For example, a prompt might read:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.

At 302, an additional prompt or set of instructions may be applied to further condition, constrain, or refine the generated textual output, for example by specifying tone, style, subject matter, or intended audience parameters. For example, a prompt might read:
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

At 303, prompts may be used that describes the demographics of the target consumer. Each parenthetical entry is optional and is provided via connection (e.g., 112, 212) by a supply-side platform (SSP) (e.g., 105, 205). For example, a prompt for a list of demographics may be as follows:
Demographics of the Target Consumer:
[Consumer's age range.]
[Consumer's gender.]
[Geographical region or country.]
[Consumer's income range.]
[Consumer's interests.]
[Consumer's relevant past behaviors.]

At 304, a prompt may be used that describes the characteristics of the product being advertised. Each parenthetical entry is optional. For example, a prompt may be provided such as:
Subject-Product Descriptors:
[Product name.]
[URL of product webpage.]
[Product's key benefits.]
[Products to compare with the subject product.]
[Products that complement the subject product.]
[Products that might be replaced by the subject product.]
[Brand guidelines for the subject product.]

The product name, URL of the product web page, the product's key benefits, and the brand guidelines for the product are optionally provided by advertiser platform 201 and then communicated via connection 210 to ad-request database 203. Products that might be compared with the subject product, products that might complement the subject product, and products that might be replaced by the subject product are provided via connection 212 by SSP 205.

At 305, a prompt for ad-copy media asset generation may be provided. The prompt may contain optionally the length, tone, and style of the ad, and also the call to action to be included. For example, a prompt may be:
Subject-product Descriptors:
[Product name.]
[URL of product webpage.]
[Product's key benefits.]
[Products to compare with the subject product.]
[Products that complement the subject product.]
[Products that might be replaced by the subject product.]
[Brand guidelines for the subject product.]

This data is provided by the advertiser in text format via platform 201 and then communicated to an ad-request database.

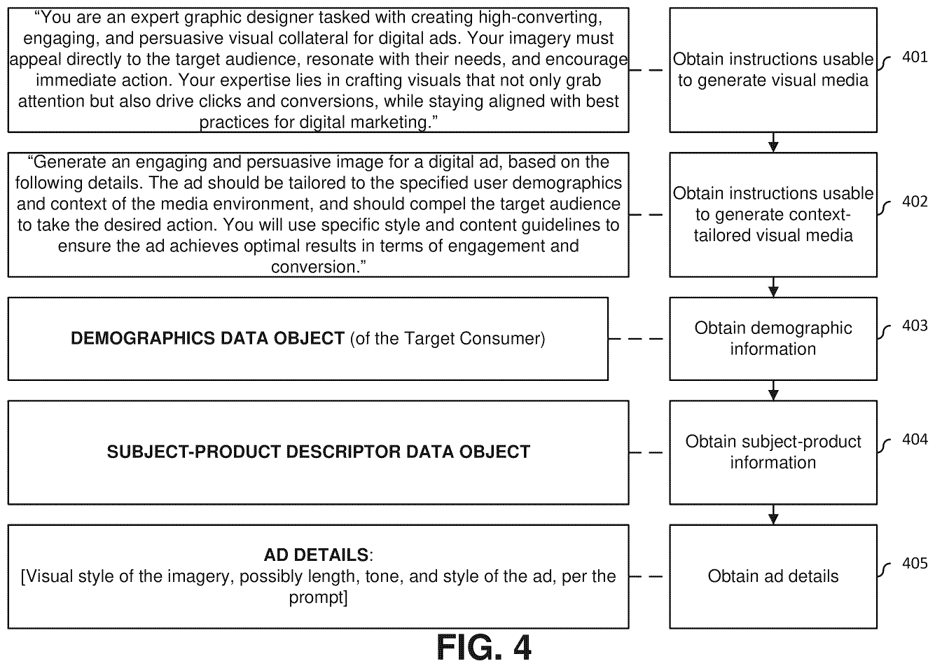

In one configuration, the prompt fed via connection 220 to DSP 204 for generating visual-collateral media assets follows the steps shown in FIG. 4. At 401, a prompt may begin with a preamble 401 further extended by another prompt 402 provided to imagery engine 209 providing general instructions for generating visual media assets. For example, prompt 401 may be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.

Prompt 402 may be:
Generate an engaging and persuasive image for a digital ad, based on the following details. The ad should be tailored to the specified user demographics and context of the media environment, and should compel the target audience to take the desired action. You will use specific style and content guidelines to ensure the ad achieves optimal results in terms of engagement and conversion.

At 403, a prompt that includes details describing the demographics of the target consumer is provided. Parenthetical entries may be provided via a connection (e.g., 112, 212) by a SSP (e.g., 105, 205). For example, details provided may be:
Demographics of the Target Consumer:
[Consumer's age range.]
[Consumer's gender.]
[Geographical region or country.]
[Consumer's income range.]
[Consumer's interests.]
[Consumer's relevant past behaviors.]

At 404, a prompt that provides details describing the characteristics of the product being advertised may be provided. At least some of the parenthetical entries may be included. For example, a prompt providing product description details may be as follows:
Subject-Product Descriptors:
[Product name.]
[URL of product webpage.]
[Product's key benefits.]
[Products to compare with the subject product.]
[Products that complement the subject product.]
[Products that might be replaced by the subject product.]
[Brand guidelines for the subject product.]

The product name, URL of the product web page, the product's key benefits, and the brand guidelines for the product may be provided by the advertiser in text format or another suitable format via platform 201 and then communicated via connection 210 to ad-requests database 203. Products that might be compared with the subject product, products that might complement the subject product, and products that might be replaced by the subject product may be provided via a connection (e.g., 112, 212) by an SSP (e.g., 105, 205).

At 405, a prompt for visual media asset generation may be provided that contains optionally a style for the visual collateral. This data may be provided by the advertiser in text format or another suitable format via the advertiser platform and then communicated 210 to ad-requests database 203. For example, a prompt providing ad details may be as follows:
Ad Details:
[visual Style of the Imagery.]

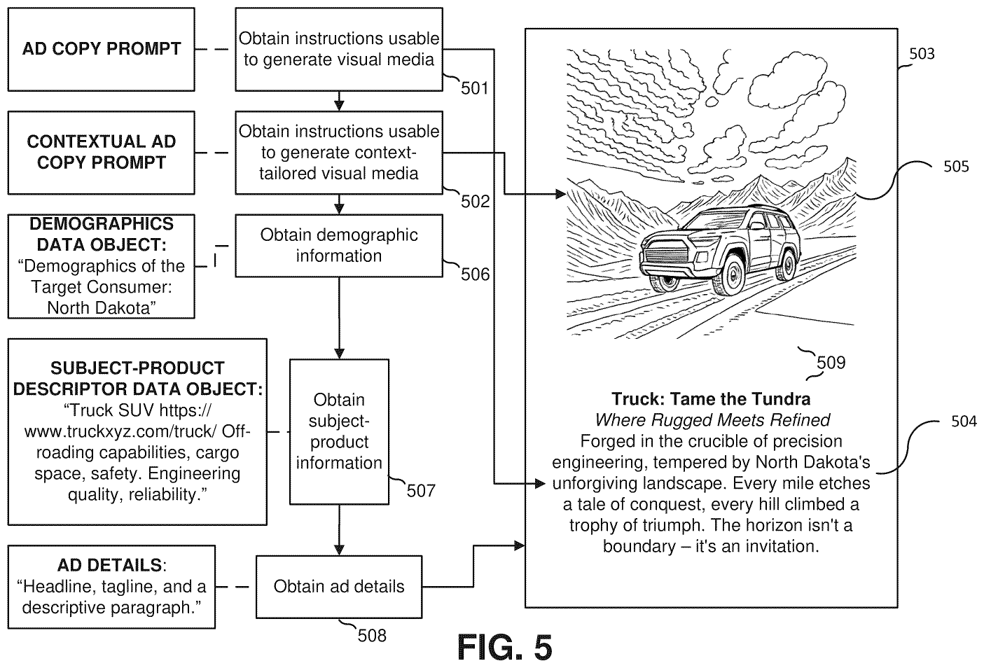

FIGS. 5-10 contain examples of computer-executable instructions (e.g., prompts) to provide to text engine 208 and/or imagery engine 209 that follow the templates in FIG. 3 and FIG. 4, along with the digital media assets generated by text engine 208 and imagery engine 209.

In one configuration, FIG. 5 illustrates a process for creating ad-copy media assets 504 and visual-collateral media assets 505 that promote a product such as a truck illustrated in media asset 503. For example, at 501 a prompt to generate ad text may be as follows:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

To create image collateral 505, for example, at 502 a prompt may be as follows:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.

Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.”

At 506, one or more prompts may be provided that describes the characteristics of the product being advertised. For example, a prompt describing the characteristics of the product being advertised may be as follows:
Demographics of the Target Consumer:
North Dakota
At 507, one or more prompts for visual media asset generation may be provided that contains optionally a style for the visual collateral. For example, a prompt may be as follows:
Subject-Product Descriptors:
Truck SUV
https://www.truckxyz./m/4runner/
Off-roading capabilities, cargo space, safety
Engineering quality, reliability

At 508, a prompt for visual media asset generation may be provided that contains optionally a style for the visual collateral. For example, a prompt may be as follows:
Ad Details:
Headline, tagline, and a descriptive paragraph.
Optionally, another prompt may be employed to further refine the ad:
Ad Details:
Use a minimalist visual style, with no text.

At 507, the product descriptors, and at 508 ad details, may be supplied by the advertiser via platform 201 and stored via connection 210 in ad-request database 203.

In this example, at 509 demographic data is supplied via a connection (e.g., 112, 212) by an SSP (e.g., 105, 205) that concerns the location of the consumer. Prompts at 501 and 502 are sent as inputs via connection 219 and connection 220 to subsystems for text engine 208 and imagery engine 209, respectively. The generated ad-copy media assets 504 and visual-collateral media assets 505 can be combined using any number of combining processes into an ad 503 that is served via connection 216 by the DSP 204 to publisher's platform 106, where it is presented via a connection 217 to a consumer platform 202.

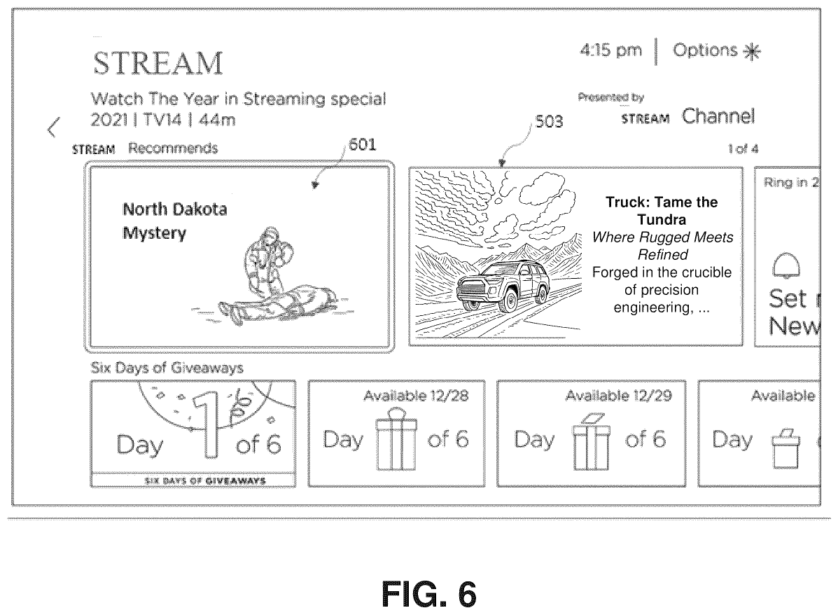

Referring to FIG. 5 and FIG. 6. FIG. 6 depicts the publisher's platform 10, which in this example is a streaming app on a connected TV. For this example, the streaming app has provided the location of the consumer's TV to SSP 105 04 205, but a connected TV could also supply other context relating to the programming being presented on the TV. Here, ad 503 is displayed in landscape form. Note that in ad 503, ad copy 505 and visual collateral 504 refer to the geographic location 509 in a plausible and convincing manner, arguing that the truck is a great car for that part of the world (e.g., snowy tundra). Moreover, note that ad 503 advertising a truck in a snowy North Dakota tundra is contextually relevant to show ad 601 “North Dakota Mystery” which advertises a show about a murder mystery in the snow of North Dakota.

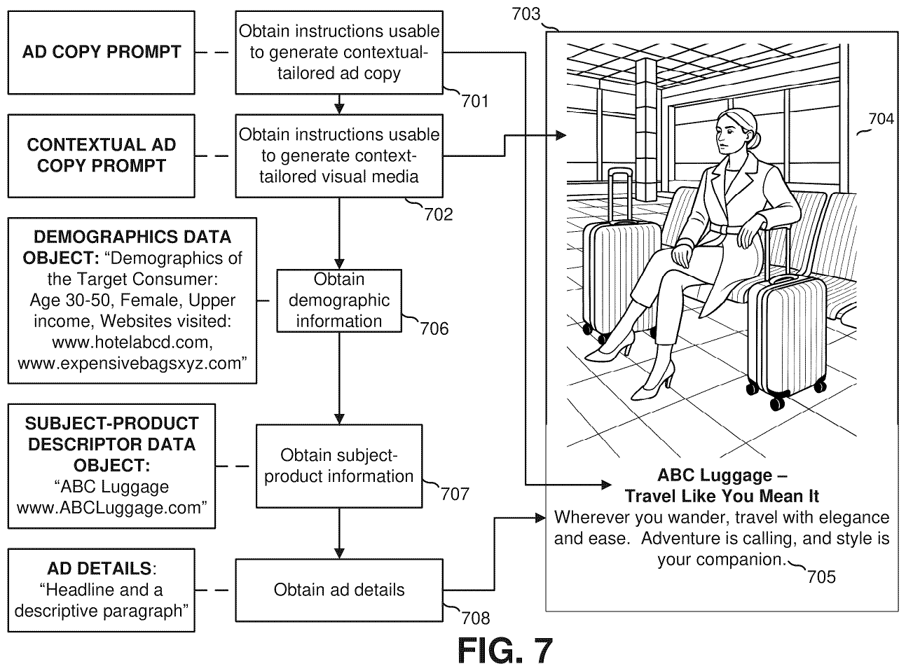

FIG. 7 illustrates an ad 703 generated using prompts for creating ad-copy media assets 705 and visual-collateral media assets 704 that promote a luggage product such as ABC luggage. At 701, one or more prompts may be used to generate text and 702 one or more prompts may be used to generate visual collateral. For example, one or more prompts at 701 might be:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

At 702, one or more prompts might be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.

Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.

In this example, at 706 demographic data is supplied by SSP 105 or 205 which, in this example, concerns the age, gender, income, and a list of websites previously visited and/or currently being viewed, and their content that the target consumer has visited recently on publisher's platform 106 or 206. For example, at 706 data provided may be:
Demographics of the Target Consumer:
Age 30-50
Female
Upper income
Websites visited: www.hotelabcd.com, www.expensivebagsxyz.com

At 707 product descriptors and at 708 ad details are supplied by platform 201 and stored 210 in ad-request database 203. Here, additional context data could be obtained by SSP 105 extracting content from the listed websites found in external data 118 or 218, which are a form of external data, via entity analysis. For example, at 707 product descriptors provided as part of a prompt might be:
Subject-product Descriptors:
ABC Luggage
www.ABCLuggage.com

At 708, ad details might be:
Ad Details:
Headline and a descriptive paragraph.

The generated ad-copy media assets 705 and visual-collateral media assets 704 may be combined into ad 703 that is served via connection 216 by DSP 204 to publisher's platform 106, where it is presented via connection 117 to consumer 102.

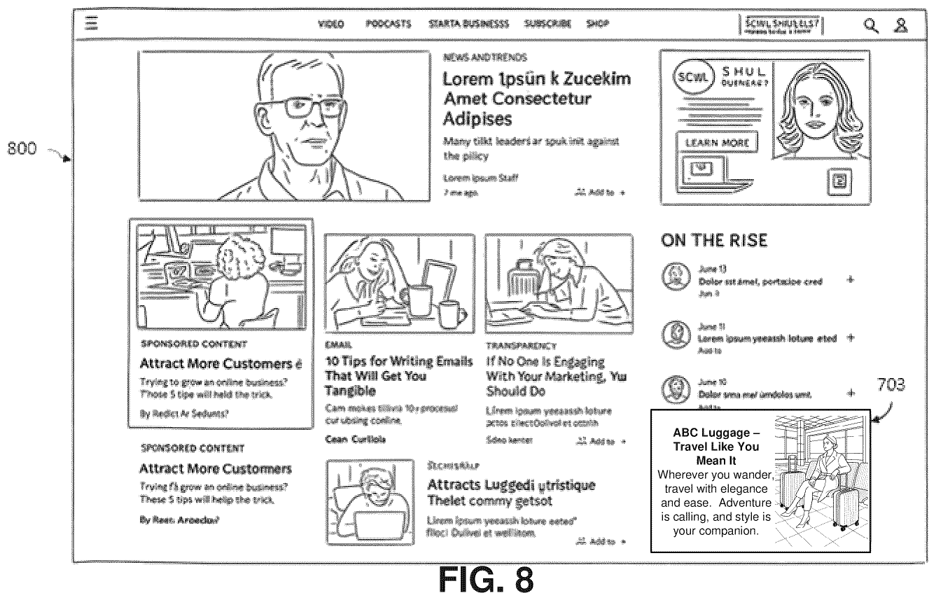

FIG. 8 depicts the publisher's platform 106, which in this example is a website 800 for an online magazine. Ad copy 705 and visual collateral 704 resonate with the current website and/or the prior website history 706 by referring to travel and luxury.

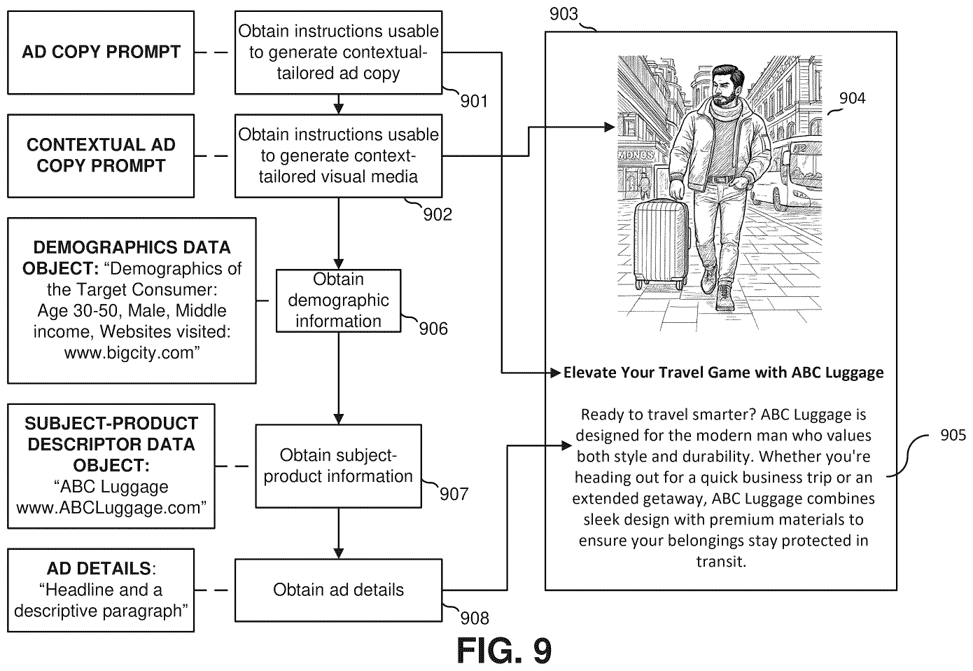

FIG. 9 illustrates an ad 903 generated using prompts for creating ad-copy media assets and visual-collateral media assets 904 that promote a luggage product such as ABC luggage. At 901, one or more prompts may be used to generate text and 902 one or more prompts may be used to generate visual collateral. For example, one or more prompts at 901 might be:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

At 902, one or more prompts might be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.
Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.

In this example, at 906 demographic data is supplied by SSP 105 which in this example concerns the age, gender, income, and a list of websites previously visited and/or currently being viewed, and their content that the target consumer has visited recently on publisher's platform 106. For example, at 906 data may be:
Demographics of the Target Consumer:
Age 30-50
Male
Middle income
Websites visited: www.bigcity.com

At 907 product descriptors and at 908 ad details are supplied by platform 201 and stored 210 in ad-request database 203. Here, additional context data could be obtained by the SSP 105 extracting content from the listed websites found in external data 118, which are a form of external data, via entity analysis. For example, at 907 product descriptors might be:
Subject-Product Descriptors:
ABC Luggage
www.ABCLuggage.com
At 908 ad details might be:
Ad Details:
Headline and a descriptive paragraph.

In this example, comparing ad 703 and ad 903 illustrates how employing system 200 and methods described herein, a different consumer context and data results in a different ad for the same product e.g., ABC Luggage. Here, the consumer is now a man who recently visited a website for a city. For example, comparing ad 703 and 903, note how the ad copy 905 and visual collateral 904 reflect both the different gender (e.g., man/woman) of the consumer and the different website-visit history (e.g., woman—www.hotelabcd.com, www.expensivebagsxyz.com, man—www.bigcity.com). Here, both ad 703 and ad 903 are each contextually relevant to the context of FIG. 8.

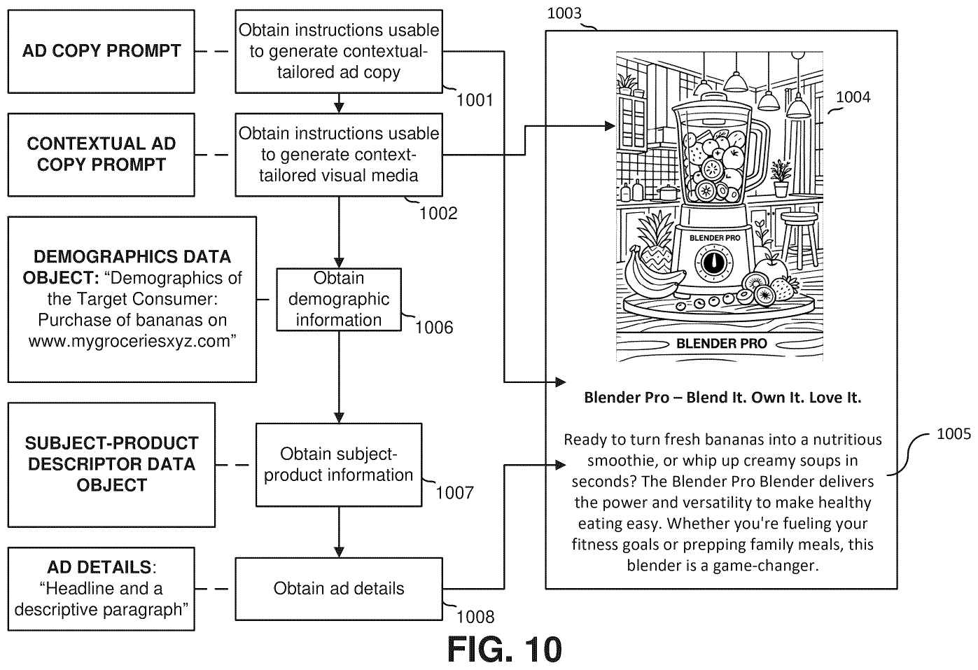

In another example, FIG. 10 contains computer instructions (e.g., prompts) and other information used for creating textual media assets 1005 and visual media assets 1004 that promote a blender. At 1001, one or more prompts may be used to generate text and 1002 one or more prompts may be used to generate visual collateral. For example, one or more prompts at 1001 for generating advertising text (e.g., ad copy) might be:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

One or more prompts at 1002 for generating visual collateral (e.g., image, video, and the like) might be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.
Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.

At 1001 and 1002, prompts are sent as inputs via connection 219 and connection 220 to subsystems for text engine 208 for textual media and imagery engine 209 for visual media, respectively.

At 1006, demographic data may be supplied by a plurality of sources such as SSP 105, which in this example concerns the age, gender, income, and a list of websites previously visited and/or currently being viewed, and their content that the target consumer has visited recently on publisher's platform 106.

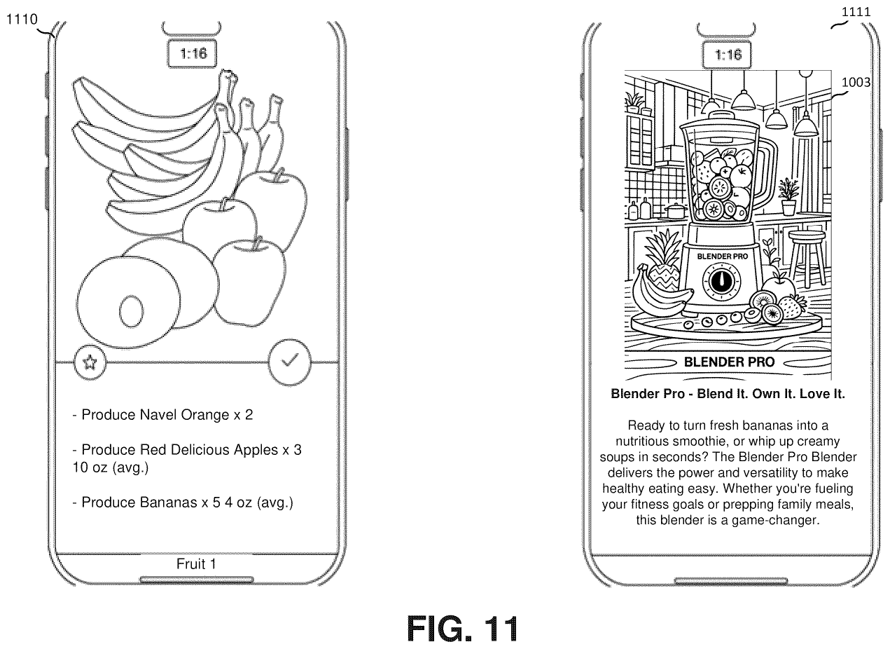

In this example at 1006, demographic data supplied via connection 212 by SSP 205 concerns a recent purchase of bananas that the target consumer has made on publisher's platform 206, which in this case might be a mobile shopping app 1111 hosted on a mobile phone 1110 as shown in FIG. 11. For example, at 1006 demographic data may be:
Demographics of the Target Consumer:
Purchase of bananas on www.mygroceriesxyz.com

At 1207, ad details might be:
Ad Details:
Headline and a descriptive paragraph.

At 1007, product descriptors might be supplied to platform 201 and delivered via connection 210 to ad-request database 203. At 1008, ad details might be supplied to platform 201 and delivered via connection 210 to ad-request database 203.

The generated ad copy 1005 and visual collateral 1004 are combined into an ad 1003 that is served via connection 216 by DSP 204 to publisher's platform 206, which in this case is a mobile shopping app 1111, shown presenting the ad 1003. The generated ad 1003 provides the context of a recent purchase of bananas to the ad for the blender by noting how a blender makes great fruit smoothies.

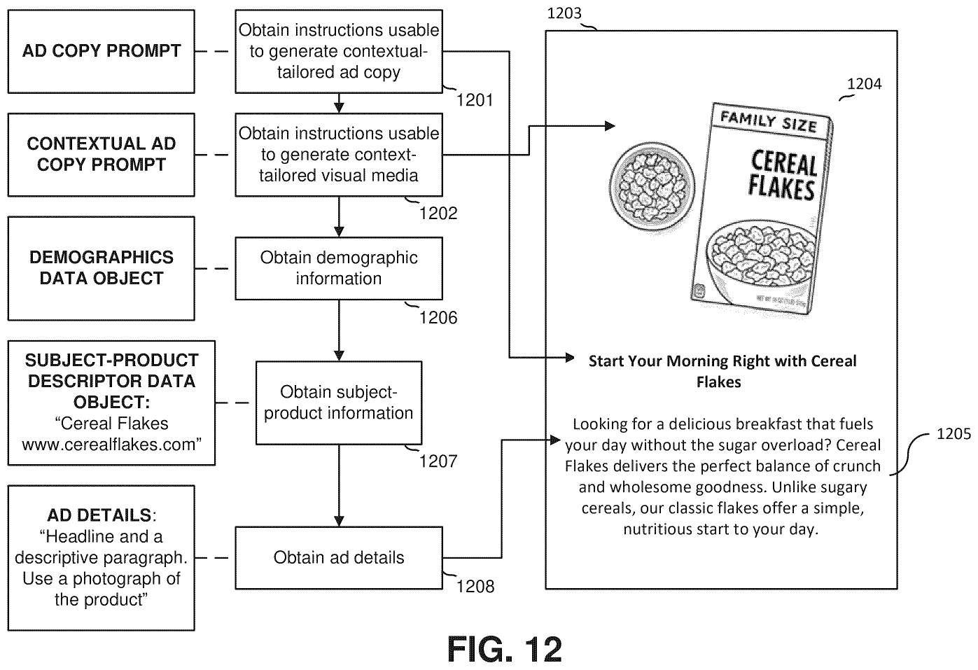

FIG. 12 illustrates an ad 1203 generated using computer instructions (e.g., prompts) for creating ad-copy media assets 1205 and visual-collateral media assets 1204 that promote a breakfast cereal called “Cereal Flakes.”

In this scenario, at 1201, one or more prompts may be used to generate text and at 1202 one or more prompts may be used to generate visual collateral. For example, one or more prompts at 1201 for generating advertising text (e.g., ad copy) might be:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

One or more prompts at 1202 for generating visual collateral (e.g., image, video, and the like) might be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.
Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.

At 1201 and 1202 prompts are sent as inputs via connection 219 and connection 220 to subsystems for text engine 208 to generate textual information and imagery engine 209 to generate visual media assets, respectively.

At 1206, demographic data is supplied by SSP 105 which in this example concerns the age, gender, income, and a list of websites previously visited and/or currently being viewed, and their content that the target consumer has visited recently on publisher's platform 106. For example, at 1206 demographic data may be:
Subject-Product Descriptors:
Cereal Flakes
www.cerealflakes.com

At 1207 ad details might be:
Ad Details:
Headline and a descriptive paragraph.
Use a photograph of the product.

These first two product descriptors are supplied by platform 201 and stored via connection 210 in ad-request database 203. One additional product descriptor relating to a competing product, “Cereal Flakes,” is supplied via connection 112 by SSP 105, which has received that information from the publisher's platform.

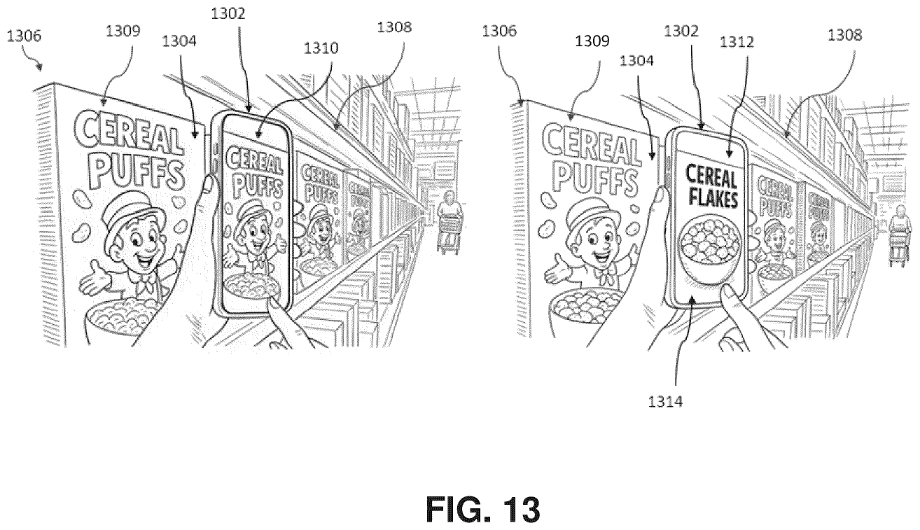

FIG. 13 depicts publisher's platform 106, which in this example is an Augmented Reality (AR) app running on a mobile device 1302. AR apps can also run on other devices like tablets or smart glasses. The app uses computer vision to scan for brand identifiers, or products, or QR codes that link to AR metadata and displayable content, in its field of camera view 1304. Here, the AR app employing a camera of mobile device 1302 has identified within camera view 1304 the logo of the Cereal Puffs 1306 cereal brand 1309 which is displayed as image 1310 on mobile device 1302.

Referring to FIG. 2, FIG. 12, and FIG. 13, in one implementation system 200 is used to replace image 1310 displayed on mobile device 1302 with a synthesized image. Here, similar to the other examples described herein, ad details 1208 may be supplied by platform 201 and stored via input 210 in ad-request database 203. Prompts 1201 and 1202 are sent as inputs via connection 219 and connection 220 to the GenAI subsystems for text engine 208 and imagery engine 209, respectively. The generated ad copy 1205 and visual collateral 1204 are combined into a synthesized ad 1312 that promotes an image of Cereal Flakes 1310 on mobile device 1302 positioned in front of the physical Cereal Puffs product 1306 situated on the physical store shelves 1308.

In another implementation, visual collateral 1204 employed to generate image 1312 may be a retrieved image rather than a synthesized one, such as specified in the ad details 1208.

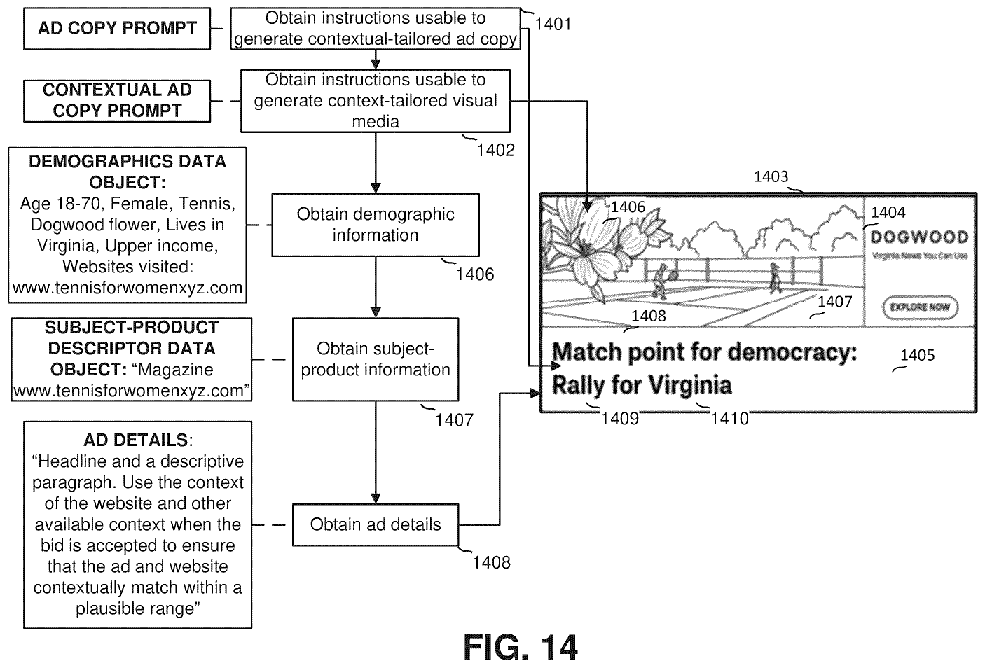

FIG. 14 illustrates an ad 1403 generated using prompts for creating ad-copy media assets 1405 and visual-collateral media assets 1404 that promote a magazine. At 1401, one or more prompts may be used to generate text and 1402 one or more prompts may be used to generate visual collateral. For example, one or more prompts might be:
You are an expert copywriter tasked with creating high-converting, engaging, and persuasive advertisement text for digital platforms. Your writing must appeal directly to the target audience, resonate with their needs, and encourage immediate action. Your expertise lies in crafting ads that not only grab attention but also drive clicks and conversions, while staying aligned with best practices for digital marketing.
Generate an engaging and persuasive advertisement text for a webpage, based on the following details. The ad should be tailored to the specified user demographics and context, and should compel the target audience to take the desired action. You will use specific tone, style, and content guidelines to ensure the ad achieves optimal results in terms of engagement and conversion.

At 1402, one or more prompts might be:
You are an expert graphic designer tasked with creating high-converting, engaging, and persuasive visual collateral for digital ads. Your imagery must appeal directly to the target audience, resonate with their needs, and encourage immediate action. Your expertise lies in crafting visuals that not only grab attention but also drive clicks and conversions, while staying aligned with best practices for digital marketing.
Generate an engaging and persuasive image for a digital ad, based on the following details. The ad should be tailored to the specified user demographics and context, and should compel the target audience to take the desired action. You will use specific style and content guidelines to ensure the ad achieves optimal results in terms of engagement and conversion.

In this example, at 1406 demographic data is supplied by SSP 105 which in this example concerns the age, gender, income, and a list of websites previously visited and/or currently being viewed, and their content that the target consumer has visited recently on publisher's platform 106. For example, demographic data may be:
Demographics of the Target Consumer:
Age 18-70
Female
Tennis
Dogwood flower
Lives in Virginia
Upper income
Websites visited: www.tennisforwomenxyz.com

At 1407 product descriptors and at 1408 ad details are supplied by platform 201 and stored 210 in ad-request database 203. Here, additional context data could be obtained by SSP extracting content from the listed websites found in external data 118, which are a form of external data, via entity analysis. For example, at 1407 product descriptors might be:
Subject-Product Descriptors:
Magazine
www.tennisforwomenxyz.com

At 1408 ad details might be:
Ad Details:
Headline and a descriptive paragraph.

Use the context of the website and other available context when the bid is accepted to ensure that the ad and website contextually match within a plausible range.

In one implementation, at least some of the elements forming image 1403, such as dogwood flower image 1406, tennis court image 1407, and textual components including “Match Point” 1408, “Rally” 1409, and “Virginia” 1410, are programmatically selected and assembled based at least in part on contextual data associated with the target media environment. The resulting media asset 1403 is contextually aligned within at least one threshold of contextual relevance with the content of the web page or other display environment in which it is rendered. This alignment satisfies a predefined contextual matching threshold, ensuring that the content generated (e.g., ad 1403) at or near the time of ad insertion is relevant to the surrounding media context at the time of insertion.

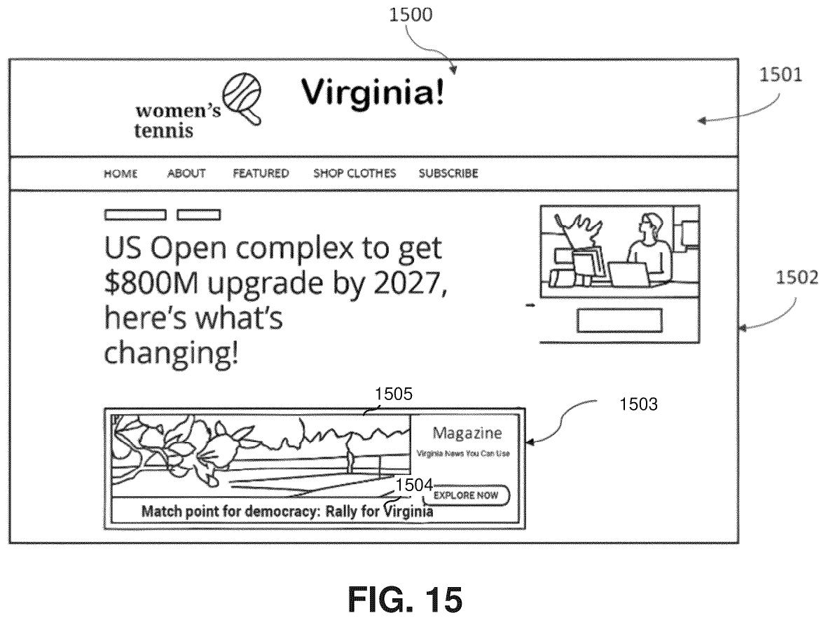

For example, FIG. 15 depicts a publisher's platform 1500, which in this case is a website 1501 rendered on a computer display 1502. In this scenario, the website 1501 has transmitted location data for the end user to SSP 105. The advertisement 1503, which includes ad copy 1505 and visual collateral 1504, has been assembled or selected based on this contextual information. Here, ad 1503 promotes a magazine and is both visually and textually relevant to the surrounding content, specifically, an article on the website 1501 about women's tennis in Virginia. The ad effectively communicates that the promoted magazine is particularly suitable for women in Virginia who are interested in tennis. This example demonstrates how programmatic content generation can yield advertisements that are plausibly and persuasively aligned with the hosting media environment across multiple contextual dimensions at or near the time of insertion.

The generated ad-copy media assets 1405 and visual-collateral media assets 1404 may be combined into ad 1403 that is served via connection 216 by DSP 204 to publisher's platform 106, where it is presented via connection 117 to consumer 102.

In the description herein, various implementations are described. For purposes of explanation, specific configurations and details are set forth in order to provide a thorough understanding of implementations described herein. However, it will also be apparent to one skilled in the art that implementations, and variations thereof, may be practiced without the specific details. Furthermore, well-known features may be omitted or simplified in order not to obscure the implementations being described.

The use of any and all examples, or exemplary language (e.g., “such as”) provided herein, is intended merely to better illuminate implementations and does not pose a limitation on the scope of implementations unless otherwise claimed. No language in the specification should be construed as indicating any non-claimed element as essential to the practice of the implementations.

In the specification, implementations have been described with reference to numerous specific details that may vary from implementation to implementation. The specification and drawings are, accordingly, to be regarded in an illustrative rather than a restrictive sense. The sole and exclusive indicator of the scope of the specification, and what is intended by the applicants to be the scope of the specification, is the literal and equivalent scope of the set of claims that issue from this application, in the specific form in which such claims issue, including any subsequent correction.

Further implementations can be envisioned to one of ordinary skill in the art after reading this disclosure. In other implementations, combinations or sub-combinations of the above-disclosed invention can be advantageously made. The example arrangements of components are shown for purposes of illustration and it should be understood that combinations, additions, re-arrangements, and the like are contemplated in alternative implementations. Thus, while the specification has been described with respect to exemplary implementations, one skilled in the art will recognize that numerous modifications are possible.

For example, the processes described herein may be implemented using hardware components, software components, and/or any combination thereof. A combination of hardware and software components is sometimes referred to as a platform. The specification and drawings are, accordingly, to be regarded in an illustrative rather than a restrictive sense. It will, however, be evident that various modifications and changes may be made thereunto without departing from the broader spirit and scope of the specification as set forth in the claims and that the specification is intended to cover all modifications and equivalents within the scope of the following claims.

Herein, Generative AI (GenAI) refers to a machine-learning technology capable of generating text, images, videos, or other data using neural networks, often in response to prompts. GenAI models learn the patterns and structure of their input training data and then generate new data, text, or imagery, that has similar characteristics. GenAI models for text generation are often called Large Language Models (LLMs). Various techniques are available to speed up LLMs and to trade off text quality for speed to improve application performance such as speculative streaming, a technique where the LLM is fine-tuned to predict future n-grams alongside next-token outputs, conditioning on key video frames, or parsing user prompts into logical representations for data querying. One type of GenAI model for text-to-image generation is called Stable Diffusion which uses fine-grained spatial conditioning of large, pretrained text-to-image models. Techniques are available to speed up Stable Diffusion models and trade off image quality for speed to improve application performance.

While certain implementations described herein reference the use of LLMs, it should be understood that any computing system or computing infrastructure capable of executing instructions, performing computations, or managing data processing tasks may be utilized to implement the disclosed techniques, regardless of whether such a system hosts or interacts with an LLM.

As used herein, the terms “LLM,” “computer,” “computing system” and the like refers broadly to any hardware and/or software configuration suitable for performing one or more functions described in this disclosure. A computing system may include, without limitation, one or more processors (e.g., central processing units (CPUs), graphics processing units (GPUs), tensor processing units (TPUs), application-specific integrated circuits (ASICs), field-programmable gate arrays (FPGAs)), memory components (e.g., volatile and non-volatile memory), and interconnects (e.g., buses, communication interfaces, system-on-chip architecture).

As used herein, the term “user” refers to any requesting entity, including but not limited to human operators and automated agents or systems. Examples of users include, but are not limited to: a human interacting with a user interface (e.g., via a web browser or mobile application), a software agent making API calls (e.g., an automated scheduler or script), a machine learning model requesting data for inference, a server-side application requesting resources from a microservice, a robotic system issuing commands to a cloud-based control system, an IoT device initiating a data retrieval or command operation, etc.

Here, the term “advertisement ,” or more generally “Ad,” refers broadly to a digital media asset which typically includes textual ad copy and for visual collateral, an image, and/or video.

As used herein, the term “advertiser” refers to an entity, which may include an individual, organization, software system, or automated agent, that provides, selects, configures, or submits media content (e.g., advertisements, promotional materials, branded messages) for delivery to a target audience via one or more media distribution channels.

An advertiser may specify delivery criteria such as target demographics, contextual relevance, bid values, campaign objectives, creative assets, performance metrics, and optimization goals. In some implementations, an advertiser may interact with the system directly (e.g., via a user interface or application programming interface), or indirectly through an intermediary platform (e.g., a demand-side platform (DSP), agency, or campaign manager).

In some implementations, computing systems may be configured to execute a LLM locally, or may access and interact with an LLM hosted in a remote or distributed computing environment (e.g., cloud-based or edge computing architectures). The computing system may also include storage for parameters, input/output interfaces, and hardware accelerators to support operations such as matrix computation, neural network inference, or any other algorithmic processes necessary to carry out the described functionality.

In some implementations, the computing system may support parallel or distributed processing across multiple nodes, including execution of auxiliary components such as vector databases, caching layers, or task-specific pipelines for preprocessing, postprocessing, retrieval, and model orchestration. Such systems may operate synchronously or asynchronously with the LLM to support real-time or near-real-time applications.

As described herein, metadata for an advertisement often includes some targeting data, such as the desired demographics or behavioral profiles of the consumers the advertiser would like to reach. The metadata may also typically include some other information such as pricing guidelines, which describes a maximum price that the advertiser is willing to pay for each ad impression.

The term “Programmatic media procurement” refers to a process and media procurement environment that involves multiple distributed computers connected by a computer network, and is performed in a very short time, typically under two hundred milliseconds. The current standard process for programmatic ad buying is called the Open Real Time Bidding (OpenRTB) protocol.

The discussion herein relates to an example advertising request in a programmatic media procurement delivering digital assets for advertising purposes but could be applied to any digital media request, digital asset, and digital media delivery environment.

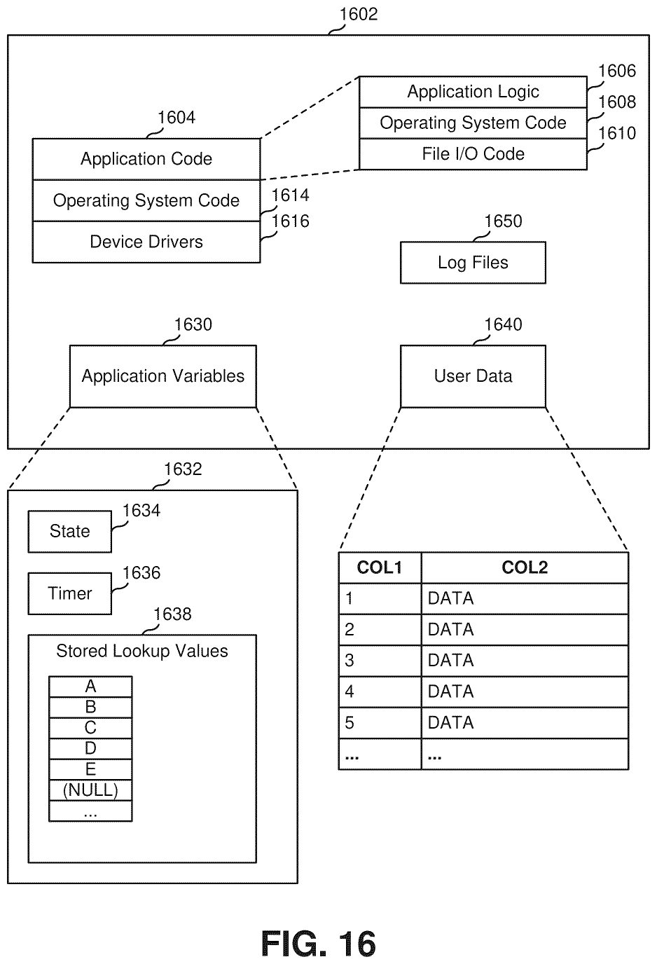

FIG. 16 is a simplified functional block diagram of a storage device 1602 having an application that can be accessed and executed by a processor in a computer system as might be part of examples of a media generation system and/or a computer system that generates media. FIG. 16 also illustrates an example of memory elements that might be used by a processor to implement elements of the examples described herein. In some examples, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 1602 can be one or more memory device that can be accessed by a processor and storage device 1602 can have stored thereon application code 1604 that can be one or more processor readable instructions, in the form of write-only memory and/or writable memory. Application code 1604 can include application logic 1606, library functions 1608, and file I/O functions code 1610 associated with the application. The memory elements of FIG. 16 might be used for a server or computer that interfaces with a user, generates data, and/or manages other aspects of a process described herein. In addition to application code 1604, storage device 1602 might also contain operating system code 1614 and device drivers 1616.

Storage device 1602 can also include storage for application variables 1630 that can include one or more storage locations configured to receive variables 1632. Application variables 1630 can include variables that are generated by the application or otherwise local to the application, such as state variables 1634, timers 1636, and/or stored lookup values 1638. Application variables 1630 can be generated, for example, from data retrieved from an external source, such as a user or an external device or application. A processor can execute application code 1604 to generate application variables 1630 provided to storage device 1602. Application variables 1630 might include operational details needed to perform the functions described herein.

Storage device 1602 can include storage for databases and other data described herein. One or more memory locations can be configured to store user data 1640, which might include data sourced by an external source, such as a user or an external device. User data 1640 can include, for example, records being passed between servers prior to being transmitted or after being received. Other data might also be supplied.

Storage device 1602 can also include log files 1650 having one or more storage locations configured to store results of the application or inputs provided to the application. For example, log files 1650 can be configured to store a history of actions, alerts, error messages, and the like.

In some implementations, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One implementation might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

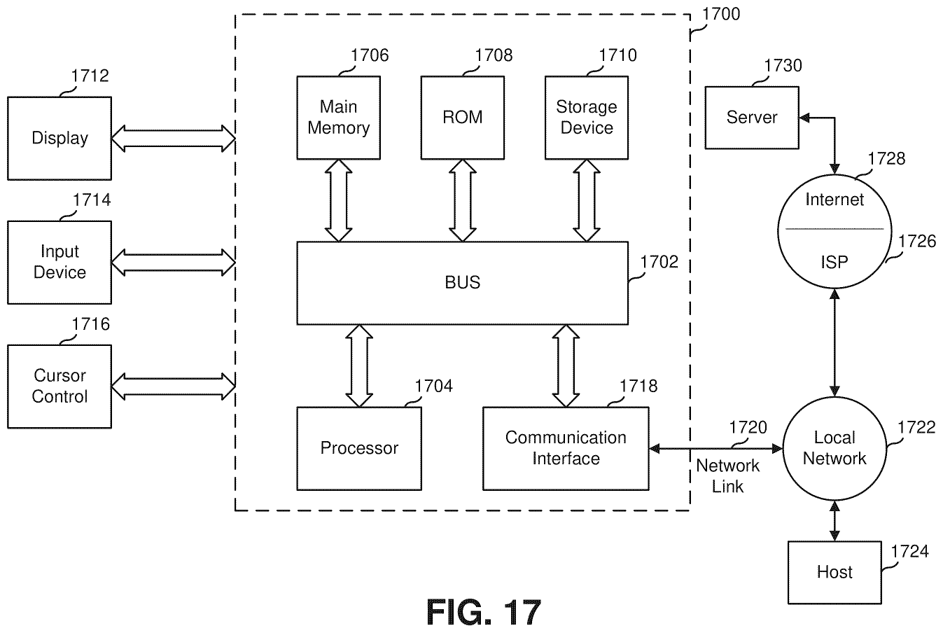

FIG. 17 is a block diagram that illustrates a computer system 1700 upon which the computer systems of the systems described herein and/or data structures shown in FIG. 16 may be implemented. Computer system 1700 includes a bus 1702 or other communication mechanism for communicating information, and a processor 1704 coupled with bus 1702 for processing information. Processor 1704 may be, for example, a general-purpose microprocessor.

Computer system 1700 also includes a main memory 1706, such as a random-access memory (RAM) or other dynamic storage device, coupled to bus 1702 for storing information and instructions to be executed by processor 1704. Main memory 1706 may also be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, such as a magnetic disk or optical disk, is provided and coupled to bus 1702 for storing information and instructions.

Computer system 1700 may be coupled via bus 1702 to a display 1712, such as a computer monitor, for displaying information to a computer user. An input device 1714, including alphanumeric and other keys, is coupled to bus 1702 for communicating information and command selections to processor 1704. Another type of user input device is a cursor control 1716, such as a mouse, a trackball, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 may implement the techniques described herein using customized hard-wired logic, one or more ASICs or FPGAs, firmware, and/or program logic which in combination with the computer system causes or programs computer system 1700 to be a special-purpose machine. The techniques herein might be performed by computer system 1700 in response to processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative implementations, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1710. Volatile media includes dynamic memory, such as main memory 1706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid-state drive of a remote computer. The remote computer can load the instructions into its dynamic memory and send the instructions over a network connection. A modem or network interface local to computer system 1700 can receive the data. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be a network card, a modem, a cable modem, or a satellite modem to provide a data communication connection to a corresponding type of telephone line or communications line. Wireless links may also be implemented. In any such implementation, communication interface 1718 sends and receives electrical, electromagnetic, or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the world-wide packet data communication network now commonly referred to as the “Internet” 1728. Local network 1722 and Internet 1728 both use electrical, electromagnetic, or optical signals that carry digital data streams. The signals through the various networks and the signals on network link 1720 and through communication interface 1718, which carry the digital data to and from computer system 1700, are example forms of transmission media.

Computer system 1700 can send messages and receive data, including program code, through the network(s), network link 1720, and communication interface 1718. In the Internet example, a server 1730 might transmit a requested code for an application program through the Internet 1728, ISP 1726, local network 1722, and communication interface 1718. The received code may be executed by processor 1704 as it is received, and/or stored in storage device 1710, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be carried by a transitory computer readable medium e.g., a transmission medium such as in the form of a signal transmitted over a network.

Embodiments of the disclosure can be described in view of the following clauses.
Clause 1. A computer-implemented method, comprising obtaining, during an advertising auction, context data that, at least in part, characterizes an active user session within a digital media environment, in a first operation, utilizing the context data to generate one or more creative media objects to form one or more advertisement objects, wherein the advertisement objects depend upon the context data, in a second operation, preparing and transmitting a bid to the advertising auction, and in a third operation, in response to acceptance of the transmitted bid, transmitting an advertisement, comprising the one or more advertisement objects, for presentation to the user.
Clause 2. The method of clause 1, wherein the first, second, and third operations are integrated with a real-time programmatic ad-buying platform.
Clause 3. The method of clause 1 of clause 2, wherein the context data includes context data from one or more of: URLs and domain structure; webpage text: HTML body content, headlines, metadata; keywords; HTML meta tags, IAB and other category codes with a standardized classification of content, tags and taxonomies, visual content, alt tags, image recognition, video content, transcript, frame image analysis, scene or face recognition, speech recognition and keywords, emotional tone, speaker identity, app metadata, app content data, user-based context, cookies, local storage/session storage, device identifiers, (IDFA, GAID, MAC address), geolocation, IP, browser fingerprinting, biometric data, sensor data from device, accelerometer, gyroscope, light sensors, OS and device characteristics, behavioral and historical data, search queries, clickstream data, ad interaction history, purchase and conversion history, login status, time of day, date, day of week, recency/frequency metrics, CRM and DMP integrations, unified ID, social media history, first-party databases such as CRM and purchase data, site behavior; third-party data providers providing demographics, interest and affinities, purchase intent signals, household purchase, behavior and ownership data, Customer Data Platforms, Data Clean Rooms; contextual environment and signals, location data, GPS, IP, Beacon/Wi-Fi, weather, current events, news events, language and local settings, compliance and consent signals, consent strings, privacy signals from browsers, privacy signals from apps, social media post text and captions, hashtags and mentions, likes, shares, comments, view through rates, creator metadata, follower count, topic category, verified status, social graph, network of social connections, influencer interaction paths, social content type, interaction timing, video metadata, video and image brand logos, video and image product placement, scene classification, channel data, creator category, channel subscriber count, viewer behavior, playlist inclusion, content recommendation context, skip behavior, hover behavior, connected TV program-level metadata, show title, genre, episode, AR metadata and content context, QR codes that index AR metadata and displayable content, VR metadata and content context, smart TV model and OS, AR model and OS, VR model and OS, podcast metadata, host-read vs dynamically inserted content, listener behavior, listening context, background play status, connected devices, subscription tier, playlist inclusion, and/or cross-platform ID graphs.
Clause 4. The method of any one of clauses 1 to 3, wherein prior to using the context data, the context data is k-anonymized.
Clause 5. The method of any one of clauses 1 to 4, wherein the generation of the media objects that form the advertisement object occurs at least partially after the acceptance of the bid.
Clause 6. The method of any one of clauses 1 to 5, wherein the representation of the advertisement comprises a placeholder object providing detail of the advertisement sufficient to represent the advertisement to a third party for bid acceptance.
Clause 7. The method of any one of clauses 1 to 6, wherein the auction is one or more of a first-price auction, a second-price auction, a Vickery auction, a private marketplace auction, a hybrid first-and second-price option, a Dutch auction, a dynamic floor price mechanism, a cryptographic verification auction, a sequential auction, a sequential auction with a learning algorithm, a token-based auction, and/or a blockchain auction.
Clause 8. The method of any one of clauses 1 to 7, wherein the generation of the media objects that form the advertisement object employs at least one generative machine-learning model.
Clause 9. The method of any one of clauses 1 to 8, wherein at least one generative machine-learning model employs weights of eight bits or fewer that are selected to obtain the advertisement in fewer processing cycles.
Clause 10. The method of any one of clauses 1 to 9, further comprising determining a contextual relevancy value for the advertisement given the digital media environment, and determining during the advertising auction whether the contextual relevancy value exceeds a contextual relevancy threshold.
Clause 11. The method of any one of clauses 1 to 10, further comprising determining a quality level for the advertisement given the digital media environment, and determining during the advertising auction whether the quality level exceeds a quality threshold.
Clause 12. The method of any one of clauses 1 to 11, wherein at least a portion of the computer implemented method is performed on a hardware system configured to reduce processing cycles and processing time to generate the advertisement.
Clause 13. A computer-implemented method for generating an advertising object to be inserted into an advertising slot made available via a programmatic ad-buying platform, the computer-implemented method comprising determining a context data object, wherein the context data object indicates at least one of the context for the user session presentation or the context of the advertising slot, determining that an advertising auction has opened that entails bidding for placement of an advertising object in an advertising slot, after the advertising auction has opened, generating one or more creative media objects based, at least in part, on the context data object, combining the one or more creative media objects to form one or more advertisement objects usable for placement in the ad slot, placing a bid in the advertising auction, and if the bid wins the advertising auction, providing an advertisement, comprising the one or more advertisement objects, for placement in the ad slot.
Clause 14. The computer-implemented method of clause 13, wherein combining the creative media objects to form the advertisement object occurs before the bid wins the advertising auction.
Clause 15. The computer-implemented method of clause 13 of clause 14, wherein combining the creative media objects to form the advertisement object occurs before the advertising auction concludes.
Clause 16. The computer-implemented method of any one of clauses 13 to 1, further comprising determining, during the advertising auction and after the advertisement object is formed, a contextual relevancy value of the advertisement object relative at least one of the context for the user session presentation or the context of the advertising slot, and comparing, during the advertising auction, whether the contextual relevancy value exceeds a pre-determined contextual relevancy threshold.
Clause 17. The computer-implemented method of any one of clauses 13 to 16, further comprising determining a bid value based on the contextual relevancy value.
Clause 18. The computer-implemented method of any one of clauses 13 to 17, wherein the context data object indicating context for at least one of the contexts for the user session presentation or the context of the advertising slot indicates additional context representing one or more of user history and user cookies.
Clause 19. A computer-implemented method, comprising obtaining, during a private placement deal, preferred deal, or programmatic guaranteed deal, context data that, at least in part, characterizes an active user session within a digital media environment, in a first operation, utilizing the context data to generate one or more creative media objects to form an advertisement object, wherein the advertisement depends upon the context data, in a second operation, preparing and transmitting the advertisement for presentation to the user.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate examples and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

1. A computer-implemented method, comprising:
obtaining, during an advertising auction, context data that, at least in part, characterizes an active user session within a digital media environment;
in a first operation, utilizing the context data to generate one or more creative media objects to form one or more advertisement objects, wherein the advertisement objects depend upon the context data;
in a second operation, preparing and transmitting a bid to the advertising auction; and
in a third operation, in response to acceptance of the transmitted bid, transmitting an advertisement, comprising the one or more advertisement objects, for presentation to the user.

2. The method of claim 1, wherein the first, second, and third operations are integrated with a real-time programmatic ad-buying platform.

3. The method of claim 1, wherein the context data includes context data from one or more of: URLs and domain structure; webpage text: HTML body content, headlines, metadata; keywords; HTML meta tags, IAB and other category codes with a standardized classification of content, tags and taxonomies, visual content, alt tags, image recognition, video content, transcript, frame image analysis, scene or face recognition, speech recognition and keywords, emotional tone, speaker identity, app metadata, app content data, user-based context, cookies, local storage/session storage, device identifiers, (IDFA, GAID, MAC address), geolocation, IP, browser fingerprinting, biometric data, sensor data from device, accelerometer, gyroscope, light sensors, OS and device characteristics, behavioral and historical data, search queries, clickstream data, ad interaction history, purchase and conversion history, login status, time of day, date, day of week, recency/frequency metrics, CRM and DMP integrations, unified ID, social media history, first-party databases such as CRM and purchase data, site behavior; third-party data providers providing demographics, interest and affinities, purchase intent signals, household purchase, behavior and ownership data, Customer Data Platforms, Data Clean Rooms; contextual environment and signals, location data, GPS, IP, Beacon/Wi-Fi, weather, current events, news events, language and local settings, compliance and consent signals, consent strings, privacy signals from browsers, privacy signals from apps, social media post text and captions, hashtags and mentions, likes, shares, comments, view through rates, creator metadata, follower count, topic category, verified status, social graph, network of social connections, influencer interaction paths, social content type, interaction timing, video metadata, video and image brand logos, video and image product placement, scene classification, channel data, creator category, channel subscriber count, viewer behavior, playlist inclusion, content recommendation context, skip behavior, hover behavior, connected TV program-level metadata, show title, genre, episode, AR metadata and content context, QR codes that index AR metadata and displayable content, VR metadata and content context, smart TV model and OS, AR model and OS, VR model and OS, podcast metadata, host-read vs dynamically inserted content, listener behavior, listening context, background play status, connected devices, subscription tier, playlist inclusion, and/or cross-platform ID graphs.

4. The method of claim 1, wherein prior to using the context data, the context data is k-anonymized.

5. The method of claim 1, wherein the generation of the media objects that form the advertisement object occurs at least partially after the acceptance of the bid.

6. The method of claim 1, wherein the representation of the advertisement comprises a placeholder object providing detail of the advertisement sufficient to represent the advertisement to a third party for bid acceptance.

7. The method of claim 1, wherein the auction is one or more of a first-price auction, a second-price auction, a Vickery auction, a private marketplace auction, a hybrid first-and second-price option, a Dutch auction, a dynamic floor price mechanism, a cryptographic verification auction, a sequential auction, a sequential auction with a learning algorithm, a token-based auction, and/or a blockchain auction.

8. The method of claim 1, wherein the generation of the media objects that form the advertisement object employs at least one generative machine-learning model.

9. The method of claim 1, wherein at least one generative machine-learning model employs weights of eight bits or fewer that are selected to obtain the advertisement in fewer processing cycles.

10. The method of claim 1, further comprising:
determining a contextual relevancy value for the advertisement given the digital media environment; and
determining during the advertising auction whether the contextual relevancy value exceeds a contextual relevancy threshold.

11. The method of claim 1, further comprising:
determining a quality level for the advertisement given the digital media environment; and
determining during the advertising auction whether the quality level exceeds a quality threshold.

12. The method of claim 1, wherein at least a portion of the computer implemented method is performed on a hardware system configured to reduce processing cycles and processing time to generate the advertisement.

13. A computer-implemented method for generating an advertising object to be inserted into an advertising slot made available via a programmatic ad-buying platform, the computer-implemented method comprising:
determining a context data object, wherein the context data object indicates at least one of the context for the user session presentation or the context of the advertising slot;
determining that an advertising auction has opened that entails bidding for placement of an advertising object in an advertising slot;
after the advertising auction has opened, generating one or more creative media objects based, at least in part, on the context data object;
combining the one or more creative media objects to form one or more advertisement objects usable for placement in the ad slot;
placing a bid in the advertising auction; and
if the bid wins the advertising auction, providing an advertisement, comprising the one or more advertisement objects, for placement in the ad slot.

14. The computer-implemented method of claim 13, wherein combining the creative media objects to form the advertisement object occurs before the bid wins the advertising auction.

15. The computer-implemented method of claim 13, wherein combining the creative media objects to form the advertisement object occurs before the advertising auction concludes.

16. The computer-implemented method of claim 13, further comprising:
determining, during the advertising auction and after the advertisement object is formed, a contextual relevancy value of the advertisement object relative to at least one of the context for the user session presentation or the context of the advertising slot; and
comparing, during the advertising auction, whether the contextual relevancy value exceeds a pre-determined contextual relevancy threshold.

17. The computer-implemented method of claim 13, further comprising:
determining a bid value based on the contextual relevancy value.

18. The computer-implemented method of claim 13, wherein the context data object indicating context for at least one of the contexts for the user session presentation or the context of the advertising slot indicates additional context representing one or more of user history and user cookies.

19. A computer-implemented method, comprising:
obtaining, during a private placement deal, preferred deal, or programmatic guaranteed deal, context data that, at least in part, characterizes an active user session within a digital media environment;
in a first operation, utilizing the context data to generate one or more creative media objects to form an advertisement object, wherein the advertisement depends upon the context data;
in a second operation, preparing and transmitting the advertisement for presentation to the user.
